(19) United States
(12) Patent Application Publication
(10) Pub. No.: US 2019/0300634 A1
(43) Pub. Date: Oct. 3, 2019

(54) DUST SUPPRESSION COMPOSITIONS AND METHODS

(71) Applicant: 3M INNOVATIVE PROPERTIES COMPANY, St. Paul, MN (US)

(72) Inventors: Susannah C. Clear, Hastings, MN (US); Mahfuza B. Ali, Mendota Heights, MN (US); Vasav Sahni, St. Paul, MN (US)

(21) Appl. No.: 16/302,347

(22) PCT Filed: May 16, 2017
(86) PCT No.: PCT/US2017/032817

§ 371 Date: Nov. 16, 2018

Related U.S. Application Data
(60) Provisional application No. 62/339,191, filed on May 20, 2016.

(51) Int. Cl. C08F 220/18; C09K 3/22; C08L 33/08; C08L 33/10; C08F 220/34; C08K 5/053

(52) U.S. Cl. CPC C08F 220/18; C09K 3/22; C08L 33/08; C08L 2201/54; C08F 220/34; C08K 5/053; C08L 33/10

(57) ABSTRACT

Dust suppression compositions include at least one cationic or zwitterionic (meth)acrylate-based copolymer and at least one solvent, where the solvent can be water, an aqueous mixture, or one or more non-water solvents. The dust suppression composition can also include a plasticizer, generally glycerol. The dust suppression compositions are suitable for use with sand mixtures, especially silica sand mixtures.

### FIELD OF THE DISCLOSURE

The present disclosure relates generally to the field of compositions for suppressing dust and to methods for suppressing dust that use such compositions.

### BACKGROUND

The presence of particulate matter (i.e. dust) is a serious hazard with respect to the environment and in general, to the personal health and safety of individuals exposed to it. Examples of dust forming material include iron ores, coal and other friable (i.e. a material that is easily broken up into small pieces) materials. These materials are generally referred to as dusting materials. Dust can already be in existence or can be produced as a result of mechanical operations such as mining, loading, transportation, storage and handling processes of dusting materials. Dust suppression, is generally defined as the prevention or reduction of the amount of fine particulates airborne or suspended in the air. There are chemical and mechanical methods for dust suppression. Mechanical methods include dust collection equipment such as filters and cyclones. They may capture entrained dust, induce dust to settle, ventilate the area where dust is formed, etc. Chemical methods include short and long term residual suppressants. Long term residual dust suppressants control dust through the formation of a polymer or binder film over the dusting material. The film remains over the material after evaporation of the solvent (e.g. water). Water is included in long term residual suppressants in order to provide an even spreading of the composition on the dusting material and they usually include film-forming or tackifying resins. One of the most common short term dust suppressants is water. One disadvantage of using this method lies in the fact that large quantities of water may be needed in order to fully wet the material. When used in coal, for example, it results in the decrease of its specific heating value. Another disadvantage is that water loses its effectiveness upon evaporation, thus it is not indicated for materials that are going to be transported for several days in open vehicles. Additives such as surfactants and wetting agents may be used to improve properties of the composition. Examples of short term suppressants are described in US Patent Publication No. 2005/0085407, U.S. Pat. Nos. 6,124,366 and 5,409,626. Foam suppressants form a layer over the dusting material and may be used to capture dust in its bubbles. As a result, the suppressant is only effective while the bubbles are present in the homogeneous layer. Some currently available compositions are not immediately effective, therefore requiring an extended period of time for satisfactory performance. To avoid the many problems encountered in dust reduction and to provide better means for minimizing the amount of dust escaping to the environment, a large number of products and processes have been extensively described in the literature, ranging from the utilization of natural and synthetic polymers and also using mixtures and combinations of surfactants and organic solvents. For example, U.S. Pat. No. 6,372,842 relates to a method of using an aqueous composition or dispersion containing a water-soluble or water-dispersible synthetic polymer, made of acrylate esters and alkyl substituted acrylamide and modified with an organosilane, useful for dust control and other applications, like an agricultural spray composition. Aqueous solutions are also described in U.S. Pat. No. 5,194,174 which relates to an improved non-viscous aqueous dust control solution which includes a polyvinyl alcohol and boric acid. Other examples include U.S. Pat. Nos. 4,417,992 and 4,801,635 and PCT Publication No. WO 91/00866. US Patent Publication No. 2004/0192789 provides a method for controlling dusting of material comprising the steps of: applying an effective amount of a composition comprising an alkylphenol ethoxylate surfactant, a polyglycol which can be glycerin, propylene glycol or a mixture thereof. U.S. Pat. No. 4,264,333 describes a method wherein the coal is first coated with a wetting agent and then coated with an emulsion of crude coal tar in water containing a cationic emulsifying agent. Wetting agents such as ethylene oxide may be used as described in U.S. Pat. Nos. 4,316,811 and 4,369,121. The use of ethoxylated alkyl phenols was described in U.S. Pat. Nos. 4,428,984, 4,737,305, 4,169,170. The use of emulsions is described in U.S. Pat. Nos. 4,650,598 and 4,981,398. Aromatic solvents may be used as described in U.S. Pat. No. 4,960,532 which relates to a dust suppressant composition comprising water and a thickening agent forming the dispersion medium and coal tar pitch and aromatic solvent forming the dispersed liquid. Said composition forms a resilient layer. US Patent Publication No. 2005/0045853 describes a method and composition for suppressing coal dust including a metal-containing compound mixed with any appropriate dust suppressant liquid. US Patent Publication No. 2008/0072641 describes a composition and method for dust control for solid granular materials including a glycerol reacted with a polybasic acid.

### SUMMARY

Disclosed herein are dust suppression compositions, and methods of using dust suppression compositions. In some embodiments, the dust suppression composition comprises at least one cationic or zwitterionic (meth)acrylate-based copolymer and at least one solvent, where the solvent can be water, an aqueous mixture, or one or more non-water solvents. In other embodiments, the dust suppression composition also includes a plasticizer. A variety of plasticizers are suitable, with glycerol being particularly suitable.

In some embodiments the dust suppression composition comprises at least one cationic or zwitterionic (meth)acrylate-based copolymer, and at least one solvent. The at least one cationic or zwitterionic (meth)acrylate-based copolymer comprises either Copolymer A, Copolymer B, or a combination thereof. Copolymer A is the polymerized product of about 0 wt % to 5 wt % based on the total weight of the polymer of acrylic acid, methacrylic acid, a carboxylate salt thereof, or a mixture of two or more thereof, where the amount of carboxylate salt is determined based on the weight of the corresponding free acid, about 0 wt % to 48 wt % based on the total weight of the polymer of an acrylate or methacrylate ester of an alcohol having between 8 and 12 carbons, or a mixture of two or more thereof, about 2 wt % to 45 wt % based on the total weight of the polymer of an acrylate or methacrylate ester having an alkylammonium functionality, about 0 wt % to 30 wt % based on the total weight of the polymer of vinyl acetate, isobutyl acrylate, N-vinyl pyrrolidone, or a mixture of two or more thereof, and about 50 wt % to 95 wt % based on the total weight of the polymer of 2-ethyl hexyl acrylate.

Copolymer B is the polymerized product of about 0 wt % to 5 wt % based on the total weight of the polymer of acrylic acid, methacrylic acid, a carboxylate salt thereof, or a mixture of two or more thereof, wherein the amount of carboxylate salt is determined based on the weight of the corresponding free acid, about 50 wt % to 95 wt % based on the total weight of the polymer of an acrylate or methacrylate ester of an alcohol having between 8 and 12 carbons, or a mixture of two or more thereof, about 2 wt % to 45 wt % based on the total weight of the polymer of an acrylate or methacrylate ester having an alkylammonium functionality, about 0 wt % to 30 wt % based on the total weight of the polymer of vinyl acetate, isobutyl acrylate, N-vinyl pyrrolidone, or a mixture of two or more thereof, about 0.1 wt % to 5 wt % based on the total weight of the polymer of at least one free radically polymerizable alkoxy silane.

In other embodiments the dust suppression composition comprises at least one cationic or zwitterionic (meth)acrylate-based copolymer, at least one solvent, and a plasticizer. The at least one cationic or zwitterionic (meth)acrylate-based copolymer comprises either Copolymer A, Copolymer B, or a combination thereof as described above. Typically, the plasticizer is glycerol.

Also disclosed herein are methods for treating mineral materials to suppress dust generation. Examples of mineral materials include ores, minerals, rocks, and sand. Sand mixtures, especially silica sand, can be particularly prone to the generation of dust particles, including very small dust particles. In some embodiments, the method comprises providing a sand mixture with sand grains larger than 100 micrometer average particle size and comprising dust particles of less than 100 micrometer average particle size, providing a dust suppression composition comprising at least one cationic or zwitterionic (meth)acrylate-based copolymer; and at least one solvent, treating the sand mixture with the dust suppression composition to form a treated sand mixture, optionally drying the treated sand mixture, and dispensing the treated sand mixture, such that the level of dust particles of less than 100 micrometers generated is reduced compared to an identical sand mixture that was not treated. The at least one cationic or zwitterionic (meth)acrylate-based copolymer comprises either Copolymer A, Copolymer B, or a combination thereof, as described above. In many embodiments, the dust suppression composition also includes a plasticizer, typically glycerol. While a wide variety of sand mixtures can be treated according to the methods described herein, the methods are particularly suitable for silica sand.

### DETAILED DESCRIPTION

The presence of particulate matter (i.e. dust) is a serious hazard with respect to the environment and in general, to the personal health and safety of individuals exposed to it. Examples of dust forming material include iron ores, coal and other friable (i.e. a material that is easily broken up into small pieces) materials. One such material that is becoming increasing important is sand. Sand is a naturally occurring granular material composed on finely divided rock and mineral particles. The composition of sand varies depending upon the local rock sources, but the most common constituent of sand is silica (silicon dioxide or SiO₂), usually in the form of quartz.

One class of sand that has found extensive industrial use is so-called “silica sand” or “frac sand”, sand that has a very high level of silica (typically greater than 99% quartz). The silica sand is used in the oil and gas industry in fracking operations as a proppant to keep the induced hydraulic fracture open during the fracking process.

The size range of the proppant is very important. Typical proppant sizes are generally between 8 and 140 mesh (106 micrometers-2.36 millimeters), for example 16-30 mesh (600 micrometers-1180 micrometers), 20-40 mesh (420 micrometers-840 micrometers), 30-50 mesh (300 micrometers-600 micrometers), 40-70 mesh (212 micrometers-420 micrometers) or 70-140 mesh (106 micrometers-212 micrometers). When describing frac sand, the product is frequently referred to as simply the sieve cut, i.e. 20/40 sand.

Not only does the silica sand include particles with the sizes described above, but also particles of smaller sizes that are carried along with the proppant particles. Thus a dust suppressant composition must be able to suppress not only the proppant particles but also dust of less than 100 micrometers.

The suppression of dust, especially the fine dust particles of less than 100 micrometers that is generated by silica sand, involves a number of tradeoffs. The treatment of the sand must not cause the sand to clump. In other words, the sand must remain free flowing after the treatment just like it is before the treatment. Also, the treatment must be applicable on a large scale, as the silica sand to be treated is handled in ton quantities, not gram quantities. Finally, the treatment must be practical since the treatment is employed to tons of material. Thus the need remains for dust suppression compositions and methods that can be applied to sands, such as silica sands, for large scale suppression of dust, especially dust particles of less than 100 micrometers.

While particularly suitable for suppressing dust generated by silica sands such as frac sand, the dust suppression compositions of this disclosure are suitable for use with a wide range of dust generating materials. Additionally, the dust suppression compositions of this disclosure may be applied to a wide range of dust surfaces such as mining surfaces, soil, or construction surfaces. Examples of surfaces include haul roads, mining material in an open railcar, materials on a conveyor belt, coal and mining materials such as iron ore stock piles in power plants, steel mills, unpaved rural roads, and roofing granules. Specific examples of dusty surfaces include aggregates such as crushed rock, coal, iron ore, gravel and sand.

Besides the sand mixtures described above, the dust suppression compositions of this disclosure are also well suited to suppress the dust associated with roofing granules. The dust suppression compositions suppress dust associated with storage, transfer or transport or roofing granules, such as transfer in and out of railcars, transfer to storage containers or facilities, and during transport.

Roofing granules are widely used in the roofing industry. Roofing granules are generally applied to the surface of a layer of asphalt on, for example, a roofing shingle. In general, they comprise colored slate or rock granules either in natural form or artificially colored by a ceramic coating.

In general, any mineral material which is opaque, dense, and properly graded by screening for maximum coverage can be used conventionally and in roofing products. Generally, these materials are crushed and graded to a desired size. Any size granule or distribution of sizes may be useful in the roofing material industry may be used. In various exemplary embodiments, granules have a size between about 200 to 1680 micrometers, or between 420 to 1500 micrometers, or between about 40 to 12 US mesh. Methods to color such granules are generally known in the art. See, for example, Beyard et al. in U.S. Pat. No. 3,752,696.

Suitable base granules can be selected from a wide class of relatively porous or non-porous and weather-resistant rock or mineral materials. Suitable minerals may include igneous rock, trap rocks, slates, argillite, greystone, greenstone, quartz, quartzite, certain granites or certain synthetic granules made from clay or other ceramics. The granule may be coated with a variety of materials to provide desirable properties. These coatings may be continuous or discontinuous. Multiple coatings may be applied either sequentially or simultaneously.

A variety of additives, such as stabilizers and fillers, may be utilized in asphalt-based roofing systems. For example, additives may be added to the adhesion promoting coating on the granule, for example stabilizers, antioxidants, surfactants, and the like. In addition, igneous rock mineral fines, silica, slate dust, talc, micaceous materials, dolomite, limestone and trap rock may be utilized as stabilizers or fillers in the coating asphalt.

One example of a mineral used in roofing granules is nepheline syenite. Nepheline syenite is a holocrystalline plutonic rock that consists largely of nepheline and alkali feldspar. The rocks are mostly pale colored, grey or pink, and in general appearance they are not unlike granites, but dark green varieties are also known.

A number of systems developed to suppress dust are described in the background section above. Additionally, a coating system has been developed primarily for use with roofing granules to promote adhesion of the granules to the roofing product as well as to suppress dust generated by the roofing granules. The coating compositions are described in PCT Publication No. WO 2015/157612. These coating compositions, while effective to suppress roofing granule dust, have proved not to be suitable for use with silica sand. Therefore the compositions and methods of this disclosure were developed, which suppress dust not only with mixtures such as roofing granules, but also suppress dust with sand mixtures such as silica sand mixtures.

Disclosed herein are dust suppression compositions comprising a cationic or zwitterionic copolymer emulsion or solution. In some embodiments, the dust suppression composition also comprises a plasticizer. A particularly suitable plasticizer is glycerol. The dust suppression composition can be applied to mineral materials, for example nepheline syenite or sand mixtures, such as silica sand, to suppress dust, including dust particles of less than 100 micrometers without disrupting the free flowing nature of the mineral materials.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. For example, reference to “a layer” encompasses embodiments having one, two or more layers. As used in this specification and the appended claims, the term “or” is generally employed in its sense including “and/or” unless the content clearly dictates otherwise.

The term “adhesive” as used herein refers to polymeric compositions useful to adhere together two adherends.

As used herein, the term “polymer” refers to a polymeric material that is a homopolymer or a copolymer. As used herein, the term “homopolymer” refers to a polymeric material that is the reaction product of one monomer. As used herein, the term “copolymer” refers to a polymeric material that is the reaction product of at least two different monomers.

As used herein, a “zwitterion” or “zwitterionic copolymer” refers to its usual chemical definition, namely a zwitterion is a neutral molecule with both a positive and a negative electrical charge. Multiple positive and negative charges can be present. Zwitterions are distinct from dipoles, at different locations within that molecule. Unlike simple amphoteric compounds that might only form either a cationic or anionic species depending on external conditions, a zwitterion simultaneously has both ionic states in the same molecule.

As used herein, the term “(meth)acrylate” refers both to acrylates and methacrylates. Acrylates are esters of acrylic acid and methacrylates are esters of methacrylic acid. The term “(meth)acrylate-based” when used herein to describe copolymers, refers to copolymers that comprise one or more (meth)acrylate monomers, and may comprise additional free radically polymerizable co-monomers. The ester groups of the (meth)acrylates may be simple alkyl or aryl groups, or they may include functional groups. One (meth)acrylate with a functional group included into the copolymers of this disclosure are alkylammonium groups. Alkylammonium groups are cationic groups of the type —CH₂—NR¹R²R³, wherein each R¹, R², and R³ is independently an alkyl, aryl, or alkylene group.

The terms “free radically polymerizable” and “ethylenically unsaturated” are used interchangeably and refer to a reactive group which contains a carbon-carbon double bond which is able to be polymerized via a free radical polymerization mechanism. Examples of free radically polymerizable monomers include (meth)acrylates and vinyl-functional materials such as vinyl esters, styrenes, and vinyl-functional amine compounds such as N-vinyl pyrrolidone.

The term “aqueous” as used herein is the commonly understood meaning of the term, meaning that the liquid contains at least water, but may also contain some other water miscible liquids.

The term “alkyl” refers to a monovalent group that is a radical of an alkane, which is a saturated hydrocarbon. The alkyl can be linear, branched, cyclic, or combinations thereof and typically has 1 to 20 carbon atoms. In some embodiments, the alkyl group contains 1 to 18, 1 to 12, 1 to 10, 1 to 8, 1 to 6, or 1 to 4 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, and ethylhexyl.

The term “aryl” refers to a monovalent group that is aromatic and carbocyclic. The aryl can have one to five rings that are connected to or fused to the aromatic ring. The other ring structures can be aromatic, non-aromatic, or combinations thereof. Examples of aryl groups include, but are not limited to, phenyl, biphenyl, terphenyl, anthryl, naphthyl, acenaphthyl, anthraquinonyl, phenanthryl, anthracenyl, pyrenyl, perylenyl, and fluorenyl.

The term “alkylene” refers to a divalent group that is a radical of an alkane. The alkylene can be straight-chained, branched, cyclic, or combinations thereof. The alkylene often has 1 to 20 carbon atoms. In some embodiments, the alkylene contains 1 to 18, 1 to 12, 1 to 10, 1 to 8, 1 to 6, or 1 to 4 carbon atoms. The radical centers of the alkylene can be on the same carbon atom (i.e., an alkylidene) or on different carbon atoms.

The term “heteroalkylene” refers to a divalent group that includes at least two alkylene groups connected by a thio, oxy, or —NR— where R is alkyl. The heteroalkylene can be linear, branched, cyclic, substituted with alkyl groups, or combinations thereof. Some heteroalkylenes are poloxyyalkylenes where the heteroatom is oxygen such as for example, —CH₂CH₂(OCH₂CH₂)ₙOCH₂CH₂—.

The term “arylene” refers to a divalent group that is carbocyclic and aromatic. The group has one to five rings that are connected, fused, or combinations thereof. The other rings can be aromatic, non-aromatic, or combinations thereof. In some embodiments, the arylene group has up to 5 rings, up to 4 rings, up to 3 rings, up to 2 rings, or one aromatic ring. For example, the arylene group can be phenylene.

The term “alkoxy” as used herein refers to group of the type —OR, where R is an alkyl group.

As used herein, the terms ‘room temperature” and “ambient temperature” are used interchangeably and refer to a temperature of form 20-25° C.

The terms “Tg” and “glass transition temperature” are used interchangeably and refer to the glass transition temperature of a polymeric composition. Unless otherwise specified, the glass transition temperature, if measured, is measured by DSC (Differential Scanning calorimetry) using well understood techniques (typically with a heating time of 10° C. per minute). More typically the Tg is calculated using the well-known and understood Fox equation with monomer Tg values provided by the monomer supplier, as is well understood by one of skill in the polymer arts.

The term “solvent” as used herein has a broad interpretation incorporating water, aqueous mixtures, and non-aqueous solvents. When water or an aqueous mixture is the solvent the composition is typically an emulsion. When the solvent is not water or an aqueous mixture, the composition is typically a solution. Examples of non-water solvents include ethanol, methanol, toluene, acetone, methyl ethyl ketone, ethyl acetate, isopropyl alcohol, tetrahydrofuran, 1-methyl-2-pyrrolidinone, 2-butanone, acetonitrile, dimethylformamide, dimethyl sulfoxide, dimethylacetamide, dichloromethane, t-butanol, methyl isobutyl ketone, methyl t-butyl ether, ethylene glycol, and the like.

Disclosed herein are dust suppression compositions comprising at least one cationic or zwitterionic (meth)acrylate-based copolymer and at least one solvent or dispersant media, wherein the at least one cationic or zwitterionic (meth)acrylate-based copolymer comprises Copolymer A or Copolymer B. Typically, the dust suppression compositions comprise Copolymer A or Copolymer B, however, if desired a combination of Copolymer A and Copolymer B can be used. Copolymer A is the polymerized product of about 0 wt % to 5 wt % based on the total weight of the polymer of acrylic acid, methacrylic acid, a carboxylate salt thereof, or a mixture of two or more thereof, wherein the amount of carboxylate salt is determined based on the weight of the corresponding free acid; about 0 wt % to 48 wt % based on the total weight of the polymer of an acrylate or methacrylate ester of an alcohol having between 8 and 12 carbons, or a mixture of two or more thereof; about 2 wt % to 45 wt % based on the total weight of the polymer of an acrylate or methacrylate ester having an alkylammonium functionality; about 0 wt % to 30 wt % based on the total weight of the polymer of vinyl acetate, isobutyl acrylate, N-vinyl pyrrolidone, or a mixture of two or more thereof; about 50 wt % to 95 wt % based on the total weight of the polymer of 2-ethyl hexyl acrylate. Copolymer B is the polymerized product of about 0 wt % to 5 wt % based on the total weight of the polymer of acrylic acid, methacrylic acid, a carboxylate salt thereof, or a mixture of two or more thereof, wherein the amount of carboxylate salt is determined based on the weight of the corresponding free acid; about 50 wt % to 95 wt % based on the total weight of the polymer of an acrylate or methacrylate ester of an alcohol having between 8 and 12 carbons, or a mixture of two or more thereof; about 2 wt % to 45 wt % based on the total weight of the polymer of an acrylate or methacrylate ester having an alkylammonium functionality; about 0 wt % to 30 wt % based on the total weight of the polymer of vinyl acetate, isobutyl acrylate, N-vinyl pyrrolidone, or a mixture of two or more thereof; about 0.1 wt % to 5 wt % based on the total weight of the polymer of at least one free radically polymerizable alkoxy silane.

Cationic Copolymers A are the polymerized product of polymerizable monomers including at least 50% by weight of 2-ethylhexyl acrylate (2-EHA), and a cationic monomer that is an acrylate or methacrylate ester having an alkylammonium functionality. Optionally, one or more additional monomers may be included in the cationic copolymers. In some embodiments, the cationic monomer is a mixture of two or more such cationic monomers.

In embodiments, the (meth)acrylate-based copolymer includes the 2-ethylhexyl acrylate monomer. The 2-ethylhexyl acrylate monomer is present in amounts ranging from about 50 wt % to 95 wt % of the total weight of the polymer, or at about 60 wt % to 90 wt % of the total weight of the polymer, or at about 75 wt % to 85 wt % of the total weight of the polymer, or in various intermediate levels such as 51 wt %, 52 wt %, 53 wt %, 54 wt %, and all other such values individually represented by 1 wt % increments between 50 wt % and 95 wt %, and in any range spanning between any of these individual values in 1 wt % increments, for example ranges such as about 54 wt % to 81 wt %, about 66 wt % to 82 wt %, about 77 wt % to 79 wt %, and the like.

In embodiments, the cationic monomer is an acrylate or methacrylate ester including an alkylammonium functionality. In some embodiments, the cationic monomer is a 2-(trialkyl ammonium)ethyl acrylate or a 2-(trialkylammonium)ethyl methacrylate. In such embodiments, the nature of the alkyl groups is not particularly limited; however, cost and practicality limit the number of useful embodiments. In embodiments, the 2-(trialkyl ammonium)ethyl acrylate or 2-(trialkylammonium)ethyl methacrylate is formed from the reaction of 2-(dimethylamino)ethyl acrylate or 2-(dimethylamino)ethyl methacrylate with an alkyl halide; in such embodiments, at least two of the three alkyl groups of the 2-(trialkyl ammonium)ethyl acrylate or 2-(trialkylammonium)ethyl methacrylate are methyl. In some such embodiments, all three alkyl groups are methyl groups. In other embodiments, two of the three alkyl groups are methyl and the third is a linear, branched, cyclic, or alicyclic group having between 2 and 24 carbon atoms, or between 6 and 20 carbon atoms, or between 8 and 18 carbon atoms, or 16 carbon atoms. In some embodiments, the cationic monomer is a mixture of two or more of these compounds.

The anion associated with the ammonium functionality of the cationic monomer is not particularly limited, and many anions are useful in connection with various embodiments of this disclosure. In some embodiments, the anion is a halide anion, such as chloride, bromide, fluoride, or iodide; in some such embodiments, the anion is chloride. In other embodiments the anion is BF₄, N(SO₂CF₃)₂, O₃SCF₃, or O₃SC₄F₉. In other embodiments, the anion is methyl sulfate. In still other embodiments, the anion is hydroxide. In some embodiments, the one or more cationic monomers includes a mixture of two or more of these anions. In some embodiments, polymerization is carried out using 2-(dimethylamino)ethyl acrylate or 2-(dimethylamino)ethyl methacrylate, and the corresponding ammonium functionality is formed in situ by reacting the amino groups present within the polymer with a suitable alkyl halide to form the corresponding ammonium halide functionality. In other embodiments, the ammonium functional monomer is incorporated into the cationic polymer and then the anion is exchanged to provide a different anion. In such embodiments, ion exchange is carried out using any of the conventional processes known to and commonly employed by those having skill in the art.

In embodiments, the polymerized product of the cationic monomer is present in the cationic polymer at about 2 wt % to 45 wt % based on the total weight of the cationic polymer, or at about 2 wt % to 35 wt % of the cationic polymer, or at about 4 wt % to 25 wt % of the cationic polymer, or at about 6 wt % to 15 wt % of the cationic polymer, or at about 7 wt % to 10 wt % of the cationic polymer, or in various intermediate levels such as 3 wt %, 5 wt %, 6 wt %, 8 wt %, and all other such individual values represented by 1 wt % increments between 2 and 45 wt %, and in any range spanning these individual values in 1 wt % increments, such as 2 wt % to 4 wt %, 7 wt % to 38 wt %, 20 wt % to 25 wt %, and the like.

The copolymers may also include the acrylate or methacrylate ester of an alcohol having between 8 and 12 carbons includes acrylate or methacrylate esters of linear, branched, or cyclic alcohols. While not intended to be limiting, examples of alcohols useful in the acrylate or methacrylate esters include octyl, isooctyl, nonyl, isononyl, decyl, undecyl, and dodecyl alcohol. In embodiments, the alcohol is isooctyl alcohol. In some embodiments, the acrylate or methacrylate ester of an alcohol having between 8 and 12 carbons is a mixture of two or more such compounds. In embodiments, polymerized product of the acrylate or methacrylate ester of an alcohol having between 8 and 12 carbons is present in the cationic polymer at about 0 wt % to 48 wt % of the total weight of the polymer, or in any increments in between these levels.

In embodiments, the polymerized product of one or more additional monomers is included in the cationic polymers of this disclosure. Such additional monomers are not particularly limited by structure, but exclude monomers having anionic functionality. Non-limiting examples of additional monomers are N-vinyl pyrrolidone, isobutyl (meth)acrylate, n-butyl (meth)acrylate, isopropyl (meth)acrylate, n-propyl (meth)acrylate, methyl (meth)acrylate, ethyl (meth)acrylate, vinyl acetate, hydroxyethyl (meth)acrylate, hydroxypropyl (meth)acrylate, octadecyl (meth)acrylate, stearyl (meth)acrylate, dimethyl acrylamide, N-(hydroxymethyl)-acrylamide, dimethylaminoethyl (meth)acrylate, methoxy polyethylene glycol (meth)acrylate, polydimethylsiloxane (meth)acrylate), KF 2001 (mercapto modified dimethylsiloxane), perfluorobutyl sulfonamido n-methyl ethyl acrylate, and hexafluoropropylene oxide oligomer amidol (meth)acrylate. In some embodiments, the additional monomer is a mixture of two or more of these monomers. In some embodiments, the additional monomer is vinyl acetate. In some embodiments, the additional monomer is isobutyl acrylate. In some embodiments, the additional monomer is N-vinyl pyrrolidone. In some embodiments, the additional monomer is a mixture of vinyl acetate and N-vinyl pyrrolidone.

The polymerized product of the one or more additional monomers is present in the cationic polymer at about 0 wt % to 30 wt % based on the total weight of the cationic polymer, or about 2 wt % to 20 wt % based on the total weight of the cationic polymer, or at about 3 wt % to 15 wt % of the cationic polymer, or at about 5 wt % to 10 wt % of the cationic polymer, or in various intermediate levels such as 1 wt %, 3 wt %, 4 wt %, 5 wt %, 6 wt %, 7 wt %, and all other such individual values represented by 1 wt % increments between 0 wt % and 30 wt %, and in any range spanning these individual values in 1 wt % increments, such as about 2 wt % to 4 wt %, about 11 wt % to 28 wt %, about 7 wt % to 17 wt %, and the like. All such ranges suitably include 0%.

For zwitterionic Copolymers A, in addition to the above monomers, the copolymers include the polymerized product of an anionic monomer that is acrylic acid, methacrylic acid, a salt thereof, or a blend thereof. In some embodiments the anionic monomer is acrylic or methacrylic acid, the acid is converted either before or after polymerization to a corresponding carboxylate salt by neutralization. In some embodiments, the acrylic acid, methacrylic acid, or a salt thereof is a mixture of two or more thereof.

In zwitterionic copolymer embodiments, the polymerized product of acrylic acid, methacrylic acid, a salt thereof or blend thereof is present in the zwitterionic polymer at about 0.2 wt % to 5 wt % based on the total weight of the polymer, or at about 0.5 wt % to 5 wt % of the zwitterionic polymer, or in various intermediate levels such as 0.3 wt %, 0.4 wt %, 0.6 wt %, 0.7 wt %, and all other such individual values represented by 0.1 wt % increments between 0.2 and 5.0 wt %, and in ranges spanning between any of these individual values in 0.1 wt % increments, such as 0.2 wt % to 0.9 wt %, 1.2 wt % to 3.1 wt %, and the like. In embodiments where a carboxylate salt is used, the amount of carboxylate salt is determined based on the weight of the corresponding free acid

Cationic Copolymers B are the polymerized product of polymerizable monomers including at least an acrylate or methacrylate ester of an alcohol having between 8 and 12 carbons, a cationic monomer that is an acrylate or methacrylate ester having an alkylammonium functionality, and a free radically polymerizable alkoxy silane. Optionally, one or more additional monomers are included in the cationic copolymers. In some embodiments, the cationic monomer is a mixture of two or more such cationic monomers.

In embodiments, the acrylate or methacrylate ester of an alcohol having between 8 and 12 carbons includes acrylate or methacrylate esters of linear, branched, or cyclic alcohols. While not intended to be limiting, examples of alcohols useful in the acrylate or methacrylate esters include octyl, isooctyl, nonyl, isononyl, decyl, undecyl, and dodecyl alcohol. In embodiments, the alcohol is isooctyl alcohol. In some embodiments, the acrylate or methacrylate ester of an alcohol having between 8 and 12 carbons is a mixture of two or more such compounds. In embodiments, polymerized product of the acrylate or methacrylate ester of an alcohol having between 8 and 12 carbons is present in the cationic polymer at about 50 wt % to 95 wt % of the total weight of the polymer, or at about 60 wt % to 90 wt % of the total weight of the polymer, or at about 75 wt % to 85 wt % of the total weight of the polymer, or in various intermediate levels such as 51 wt %, 52 wt %, 53 wt %, 54 wt %, and all other such values individually represented by 1 wt % increments between 50 wt % and 95 wt %, and in any range spanning between any of these individual values in 1 wt % increments, for example ranges such as about 54 wt % to 81 wt %, about 66 wt % to 82 wt %, about 77 wt % to 79 wt %, and the like.

In embodiments, the cationic monomer is an acrylate or methacrylate ester including an alkylammonium functionality. In some embodiments, the cationic monomer is a 2-(trialkyl ammonium)ethyl acrylate or a 2-(trialkylammonium)ethyl methacrylate. In such embodiments, the nature of the alkyl groups is not particularly limited; however, cost and practicality limit the number of useful embodiments. In embodiments, the 2-(trialkyl ammonium)ethyl acrylate or 2-(trialkylammonium)ethyl methacrylate is formed from the reaction of 2-(dimethylamino)ethyl acrylate or 2-(dimethylamino)ethyl methacrylate with an alkyl halide; in such embodiments, at least two of the three alkyl groups of the 2-(trialkyl ammonium)ethyl acrylate or 2-(trialkylammonium)ethyl methacrylate are methyl. In some such embodiments, all three alkyl groups are methyl groups. In other embodiments, two of the three alkyl groups are methyl and the third is a linear, branched, cyclic, or alicyclic group having between 2 and 24 carbon atoms, or between 6 and 20 carbon atoms, or between 8 and 18 carbon atoms, or 16 carbon atoms. In some embodiments, the cationic monomer is a mixture of two or more of these compounds.

The anion associated with the ammonium functionality of the cationic monomer is not particularly limited, and many anions are useful in connection with various embodiments of this disclosure. In some embodiments, the anion is a halide anion, such as chloride, bromide, fluoride, or iodide; in some such embodiments, the anion is chloride. In other embodiments the anion is BF₄, N(SO₂CF₃)₂, O₃SCF₃, or O₃SC₄F₉. In other embodiments, the anion is methyl sulfate. In still other embodiments, the anion is hydroxide. In some embodiments, the one or more cationic monomers includes a mixture of two or more of these anions. In some embodiments, polymerization is carried out using 2-(dimethylamino)ethyl acrylate or 2-(dimethylamino)ethyl methacrylate, and the corresponding ammonium functionality is formed in situ by reacting the amino groups present within the polymer with a suitable alkyl halide to form the corresponding ammonium halide functionality. In other embodiments, the ammonium functional monomer is incorporated into the cationic polymer and then the anion is exchanged to provide a different anion. In such embodiments, ion exchange is carried out using any of the conventional processes known to and commonly employed by those having skill in the art.

In embodiments, the polymerized product of the cationic monomer is present in the cationic polymer at about 2 wt % to 45 wt % based on the total weight of the cationic polymer, or at about 2 wt % to 35 wt % of the cationic polymer, or at about 4 wt % to 25 wt % of the cationic polymer, or at about 6 wt % to 15 wt % of the cationic polymer, or at about 7 wt % to 10 wt % of the cationic polymer, or in various intermediate levels such as 3 wt %, 5 wt %, 6 wt %, 8 wt %, and all other such individual values represented by 1 wt % increments between 2 and 45 wt %, and in any range spanning these individual values in 1 wt % increments, such as 2 wt % to 4 wt %, 7 wt % to 38 wt %, 20 wt % to 25 wt %, and the like.

The copolymer also includes at least one free radically polymerizable alkoxy silane. A wide range of free radically polymerizable alkoxy silanes are available. Any suitable ethylenically unsaturated alkoxy silane may be used. Such monomers contain a terminal ethylenically unsaturated group and a terminal alkoxy silane group and may be described by the general formula:

X—L₁-SiY¹Y²Y³ Formula 1

wherein X comprises an ethylenically unsaturated group; L₁ is a single covalent bond or a divalent linking group; and each of Y¹, Y², and Y³ is independently an alkoxy group or an alkyl group, such that at least one of Y¹, Y², and Y³ is an alkoxy group.

Examples of ethylenically unsaturated groups include vinyl groups and (meth)acrylate groups. (Meth)acrylate alkoxy silanes are particularly useful.

The linking group L₁ a divalent or higher valency group selected from an alkylene, arylene, heteroalkylene, or combinations thereof. L₁ can be unsubstituted or substituted with an alkyl, aryl, halo, or combinations thereof. The L₁ group typically has no more than 30 carbon atoms. In some compounds, the L₁ group has no more than 20 carbon atoms, no more than 10 carbon atoms, no more than 6 carbon atoms, or no more than 4 carbon atoms. For example, L₁ can be an alkylene, an alkylene substituted with an aryl group, or an alkylene in combination with an arylene or an alkyl ether or alkyl thioether linking group. Suitable examples of linking group L₁ include alkylene groups, especially alkylene groups with 1 to about 20 carbon atoms, arylene groups, aralkylene groups and heteroalkylene groups. Particularly useful examples include the alkylene groups ethylene (—CH₂CH₂—), propylene (—CH₂CH₂CH₂—), butylene (—CH₂CH₂CH₂CH₂—), phenylene (—C₆H₄—), and the like.

The groups Y¹, Y² and Y³ may be the same or different with the proviso that at least one is an alkoxy group. Examples of useful alkoxy groups include, for example, methoxy, ethoxy, propoxy and the like. Typical non-hydrolysable groups which may comprise Y¹, Y² and Y³ include, for example, alkyl, aryl or substituted alkyl groups such as, for example, methyl, ethyl, propyl, phenyl, tolyl, and the like.

Examples of suitable ethylenically unsaturated hydrolysable silane monomers include, for example, vinyl silanes such as vinyltrimethoxysilane, or vinyltriethoxysilane, and (meth)acrylate silanes such as, 3-(acryloyloxy)propyltrimethoxysilane, 3-(methacryloyloxy)propyltrimethoxysilane, 3-(acryloyloxy)propyltriethoxysilane, 3-(methacryloyloxy)propyltriethoxysilane, 3-(acryloyloxy)propyltripropoxysilane, 3-(methacryloyloxy)propyltripropoxysilane, {3-(acryloyloxy)propyl}methyldimethoxysilane, {3-(methacryloyloxy)propyl}methyldimethoxysilane, {3-(acryloyloxy)propyl}methyldiethoxysilane, {3-(methacryloyloxy)propyl}methyldiethoxysilane, {3-(acryloyloxy)propyl}methyldipropoxysilane, {3-(methacryloyloxy)propyl}methyldipropoxysilane, {4-(acryloyloxy)butyl}phenyldimethoxysilane, {4-(methacryloyloxy)butyl}phenyldimethoxysilane, {3-(acryloyloxy)propyl}phenyldiethoxysilane, {3-(methacryloyloxy)propyl}phenyldiethoxysilane, {3-(acryloyloxy)propyl}phenyldipropoxysilane, {3-(methacryloyloxy)propyl}phenyldipropoxysilane, {3-(acryloyloxy)propyl}dimethylmethoxysilane, {3-(methacryloyloxy)propyl}dimethylmethoxysilane, {3-(acryloyloxy)propyl}dimethylethoxysilane, {3-(methacryloyloxy)propyl}dimethylethoxysilane, {3-(acryloyloxy)propyl}phenylmethylmethoxysilane, {3-(methacryloyloxy)propyl}phenylmethylmethoxysilane, {3-(acryloyloxy)propyl}phenylmethylethoxysilane, and {3-(methacryloyloxy)propyl}phenylmethylethoxysilane. Particularly useful is 3-(methacryloyloxy)propyltrimethoxysilane, commonly known as gamma-methacryloxypropyltrimethoxysilane or 3-(trimethoxysilyl)propylmethacrylate which is commercially available as SILQUEST A-174 from Momentive.

The amount of free radically polymerizable alkoxysilane monomer present in the copolymer composition of this disclosure can be about 0.1 wt % to 5 wt % based upon the total weight of the copolymer.

In embodiments, the polymerized product of one or more additional monomers is included in the cationic polymers of this disclosure. Such additional monomers are not particularly limited by structure, but exclude monomers having anionic functionality. Non-limiting examples of additional monomers are N-vinyl pyrrolidone, isobutyl (meth)acrylate, n-butyl (meth)acrylate, isopropyl (meth)acrylate, n-propyl (meth)acrylate, methyl (meth)acrylate, ethyl (meth)acrylate, vinyl acetate, hydroxyethyl (meth)acrylate, hydroxypropyl (meth)acrylate, octadecyl (meth)acrylate, stearyl (meth)acrylate, dimethyl acrylamide, N-(hydroxymethyl)-acrylamide, dimethylaminoethyl (meth)acrylate, methoxy polyethylene glycol (meth)acrylate, perfluorobutyl sulfonamido n-methyl ethyl acrylate, and hexafluoropropylene oxide oligomer amidol (meth)acrylate. In some embodiments, the additional monomer is a mixture of two or more of these monomers. In some embodiments, the additional monomer is vinyl acetate. In some embodiments, the additional monomer is isobutyl acrylate. In some embodiments, the additional monomer is N-vinyl pyrrolidone. In some embodiments, the additional monomer is a mixture of vinyl acetate and N-vinyl pyrrolidone.

The polymerized product of the one or more additional monomers is present in the cationic polymer at about 0 wt % to 30 wt % based on the total weight of the cationic polymer, or about 2 wt % to 20 wt % based on the total weight of the cationic polymer, or at about 3 wt % to 15 wt % of the cationic polymer, or at about 5 wt % to 10 wt % of the cationic polymer, or in various intermediate levels such as 1 wt %, 3 wt %, 4 wt %, 5 wt %, 6 wt %, 7 wt %, and all other such individual values represented by 1 wt % increments between 0 wt % and 30 wt %, and in any range spanning these individual values in 1 wt % increments, such as about 2 wt % to 4 wt %, about 11 wt % to 28 wt %, about 7 wt % to 17 wt %, and the like. All such ranges suitably include 0%.

For zwitterionic Copolymers B, in addition to the above monomers, the copolymers include the polymerized product of an anionic monomer that is acrylic acid, methacrylic acid, a salt thereof, or a blend thereof. In some embodiments the anionic monomer is acrylic or methacrylic acid, the acid is converted either before or after polymerization to a corresponding carboxylate salt by neutralization. In some embodiments, the acrylic acid, methacrylic acid, or a salt thereof is a mixture of two or more thereof.

In zwitterionic copolymer embodiments, the polymerized product of acrylic acid, methacrylic acid, a salt thereof or blend thereof is present in the zwitterionic polymer at about 0.2 wt % to 5 wt % based on the total weight of the polymer, or at about 0.5 wt % to 5 wt % of the zwitterionic polymer, or in various intermediate levels such as 0.3 wt %, 0.4 wt %, 0.6 wt %, 0.7 wt %, and all other such individual values represented by 0.1 wt % increments between 0.2 and 5.0 wt %, and in ranges spanning between any of these individual values in 0.1 wt % increments, such as 0.2 wt % to 0.9 wt %, 1.2 wt % to 3.1 wt %, and the like. In embodiments where a carboxylate salt is used, the amount of carboxylate salt is determined based on the weight of the corresponding free acid

Copolymer A and Copolymer B can be prepared by a wide variety of polymerization techniques used for preparing (meth)acrylate-based copolymers. The polymerization of the polymers having quaternary ammonium functionality are carried out using conventional thermal or radiation polymerization techniques familiar to those of skill. For example, in some embodiments, the monomers are admixed, and irradiated by actinic or ionizing radiation. In some embodiments, air is partially excluded or limited in the reaction area during the irradiation. In some embodiments, an emulsion of monomer is formed and polymerization is carried out using UV or thermal initiation of the polymerization reaction. The emulsion is a water-in-oil or oil-in-water emulsion. In some embodiments, a solution of the monomers is formed in a solvent that is water, an aqueous mixture, or in a solvent other than water, and polymerization is carried out using UV or thermal initiation similarly to the emulsion reaction.

In some embodiments where UV radiation is employed, a photoinitiator is employed to initiate the polymerization reaction via photolysis of the photoinitiator. In some such embodiments, a photoinitiator is selected based on the wavelength of UV radiation to be employed. Where a photoinitiator is employed, it is included in the polymerization mixture at about 0.01 wt % to 5 wt % based on the total weight of the monomers, for example about 0.1 wt % to 2 wt % based on the total weight of the monomers, or about 0.2 wt % to 1 wt % based on the total weight of the monomers. Non-limiting examples of suitable photoinitiators include any of the metal iodides, alkyl metal compounds, or azo compounds familiar to those having skill in the art of UV initiated polymerization; and those sold under the trade name IRGACURE by Ciba Specialty Chemicals Corp. of Tarrytown, N.Y.; those sold under the trade name CHEMCURE by Sun Chemical Company of Tokyo, Japan; and those sold under the trade name LUCIRIN by BASF Corporation of Charlotte, N.C. In the case of emulsion polymerization, water-soluble initiators are particularly suitable.

In some embodiments where thermal decomposition is employed to initiate polymerization, emulsion polymerization of the monomers employed to make the polymers having quaternary ammonium functionality is carried out by blending the monomers, surfactant, and a thermal initiator in water, followed by heating the emulsion to a temperature wherein decomposition of the initiator occurs at a rate suitable to sustain a suitable rate of polymerization. Non-limiting examples of suitable thermal initiators include any of the organic peroxides or azo compounds conventionally employed by those skilled in the art of thermal initiation of polymerization, such a dicumyl peroxide, benzoyl peroxide, or azobisbutyrylnitrile (AIBN), and thermal initiators sold under the trade name VAZO by duPont deNemours and Company of Wilmington, Del. In the case of emulsion polymerization, water-soluble initiators are particularly suitable.

In other embodiments, an emulsion of monomer is formed and polymerization is carried out using UV or thermal initiation of the polymerization reaction. The emulsion is a water-in-oil or an oil-in-water emulsion. In some such embodiments, the emulsion is an oil-in-water emulsion, wherein the one or more monomers are stabilized in a bulk water phase by employing one or more surfactants. In various embodiments, the surfactant is cationic, anionic, zwitterionic, or nonionic in nature and is the structure thereof not otherwise particularly limited. In some embodiments, the surfactant is also a monomer and becomes incorporated within the polymer. In other embodiments, the surfactant is present in the polymerization reaction vessel but is not incorporated into the polymer as a result of the polymerization reaction.

Non-limiting examples of nonionic surfactants useful in forming oil-in-water emulsions of the monomers employed to form the polymers having ammonium functionality include block copolymers of ethylene oxide and propylene oxide, such as those sold under the trade names PLURONIC, KOLLIPHOR, or TETRONIC, by the BASF Corporation of Charlotte, N.C.; ethoxylates formed by the reaction of ethylene oxide with a fatty alcohol, nonylphenol, dodecyl alcohol, and the like, including those sold under the trade name TRITON, by the Dow Chemical Company of Midland, Mich.; oleyl alcohol; sorbitan esters; alkylpolyglycosides such as decyl glucoside; sorbitan tristearate; and combinations of one or more thereof.

Non-limiting examples of cationic surfactants useful in forming oil-in-water emulsions of the monomers employed to form the polymers having quaternary ammonium functionality include benzalkonium chloride, cetrimonium bromide, demethyldioctadecylammonium chloride, lauryl methyl gluceth-10 hydroxypropyl diammonium chloride, tetramethylammonium hydroxide, monoalkyltrimethyl ammonium chlorides, monoalkyldimethylbenzylammonium chlorides, dialkylethylmethylammonium ethosulfates, trialkylmethylammonium chlorides, polyoxyethylenemonoalkylmethylammonium chlorides, and diquaternaryammonium chlorides; the ammonium functional surfactants sold by Akzo Nobel N.V. of Amsterdam, the Netherlands, under the trade names ETHOQUAD, ARQUAD, and DUOQUAD; and mixtures thereof. Of particular use in forming oil-in-water emulsions for polymerization of the zwitterionic polymers of this disclosure are the ETHOQUAD surfactants, for example, ETHOQUAD C/12, C/25, C/12-75, and the like. In some embodiments, ETHOQUAD C/25 is usefully employed to make high solids emulsions in water of the monomers employed to make the polymers described herein.

Where a cationic surfactant is employed in an oil-in-water emulsion polymerization reaction, it is employed in an amount of about 0.1 wt % to 6.0 wt % based on the total weight of the monomers, or at about 0.3 wt % to 4.0 wt % of the monomers, or in various intermediate levels such as 1.1 wt %, 1.2 wt %, 1.3 wt %, 1.4 wt %, 1.5 wt %, 1.6 wt %, 1.7 wt %, 1.8 wt %, 1.9 wt %, 2.1 wt %, 2.2 wt %, and all other such individual values represented by 0.1 wt % increments between 1.0 and 6.0 wt %, and in any range spanning these individual values in 0.1 wt % increments, such as 2.3 wt % to 4.6 wt %, 4.5 wt % to 4.7 wt %, and the like.

Non-limiting examples of zwitterionic surfactants useful in forming oil-in-water emulsions of the monomers employed to form the polymers described herein include betaines and sultaines, such as cocamidopropyl betaine, hydroxysultaine, and cocamidopropyl hydroxysultaine; others include lecithin, 3-[(3-Cholamidopropyl)dimethylammonio]-1-propanesulfonate (CHAPS), and sodium 2-[1-(2-hydroxyethyl)-2-undecyl-4,5-dihydroimidazol-1-ium-1-yl]acetate (sodium lauroamphacetate). Where a zwitterionic surfactant is employed in an oil-in-water emulsion polymerization reaction, it is employed in an amount of about 0.01 wt % to 10.0 wt % based on the total weight of the monomers, or at about 0.3 wt % to 6.0 wt % of the monomers, or in various intermediate levels such as 1.1 wt %, 1.2 wt %, 1.3 wt %, 1.4 wt %, 1.5 wt %, 1.6 wt %, 1.7 wt %, 1.8 wt %, 1.9 wt %, 2.1 wt %, 2.2 wt %, and all other such individual values represented by 0.1 wt % increments between 1.0 and 10.0 wt %, and in any range spanning these individual values in 0.1 wt % increments, such as 2.3 wt % to 4.6 wt %, 4.5 wt % to 4.7 wt %, and the like.

In some embodiments, emulsion polymerization of the monomers employed to make the polymers having ammonium functionality is carried out by blending the monomers, surfactant(s), and a UV initiator in water, followed by irradiating with UV radiation at a wavelength corresponding to the preferred decomposition wavelength of the selected initiator for a period of time. In other embodiments, emulsion polymerization of the monomers is carried out by blending the monomers, surfactant, and a thermal initiator in water, followed by heating the emulsion to a temperature where decomposition of the thermal initiator is induced at a suitable rate. In some embodiments where methacrylic acid or acrylic acid are employed in the monomer mixture, sodium, lithium, ammonium, or potassium hydroxide is added to the monomer mixture to neutralize the acid functionality and form the corresponding salt. In other embodiments, such neutralization is carried out after completion of the polymerization reaction. Neutralization, in embodiments, means adjusting the pH of the water phase from between about 2 and 3 to between about 4 and 7, for example between about 5 and 6.

In some embodiments, ETHOQUAD C/25 is usefully employed to make high solids emulsions of the monomers. In this context, “solids” are defined as all ingredients of the emulsion other than water. High solids emulsions are formed, for example, at about 15 wt % and 60 wt % total solids in water, or about 25 wt % to 60 wt % total solids in water, or about 30 wt % to 50 wt % solids in water, or in various intermediate levels such as 16 wt %, 17 wt %, 18 wt %, 19 wt %, 20 wt %, 21 wt %, 22 wt %, 23 wt %, 24 wt %, 26 wt %, 27 wt %, and all other such individual values represented by 1 wt % increments between 15 wt % and 60 wt % solids in water, and in any range spanning these individual values in 1 wt % increments, such as 23 wt % to 46 wt %, 45 wt % to 57 wt %, and the like.

In general, conditions of emulsion polymerization and methodology employed are the same or similar to those employed in conventional emulsion polymerization methods. In some embodiments, the oil-in-water emulsion polymerization is carried out using thermal initiation. In such embodiments, one useful polymerization initiator is V-50 (obtained from Wako Pure Chemical Industries Ltd. of Osaka, Japan). In some such embodiments, the temperature of the emulsion is adjusted prior to and during the polymerization to about 30° C. to 100° C., for example to about 40° C. to 80° C., or about 40° C. to 60° C., or about 45° C. to 55° C. Agitation of the emulsion at elevated temperature is carried out for a suitable amount of time to decompose substantially all of the thermal initiator, and react substantially all of the monomers added to the emulsion to form a polymerized emulsion. In some embodiments, elevated temperature is maintained for a period of about 2 hours to 24 hours, or about 4 hours to 18 hours, or about 8 hours to 16 hours. During polymerization, it is necessary in some embodiments to add additional thermal initiator to complete the reaction of substantially all of the monomer content added to the reaction vessel. It will be appreciated that completion of the polymerization is achieved by careful adjustment of conditions, and standard analytical techniques, such as gas chromatographic analysis of residual monomer content, will inform the skilled artisan regarding the completion of polymerization.

In other embodiments, the polymerization is a solvent polymerization, wherein the monomers form a solution in a solvent or mixture of two or more solvents. The solvents include water but in some embodiments a non-aqueous solvent or solvent mixture is employed. Examples of suitable solvents and solvent mixtures include, in various embodiments, one or more of ethanol, methanol, toluene, acetone, methyl ethyl ketone, ethyl acetate, isopropyl alcohol, tetrahydrofuran, 1-methyl-2-pyrrolidinone, 2-butanone, acetonitrile, dimethylformamide, dimethyl sulfoxide, dimethylacetamide, dichloromethane, t-butanol, methyl isobutyl ketone, methyl t-butyl ether, and ethylene glycol. In general, conditions of solvent polymerization and methodology employed are the same or similar to those employed in conventional solvent polymerization methods. In some embodiments, the solvent polymerization is carried out using thermal initiation. In such embodiments, one useful polymerization initiator is VAZO 67. In some such embodiments, the temperature of the monomer solution is adjusted prior to and during the polymerization to about 30° C. to 150° C., for example to about 50° C. to 130° C., or about 60° C. to 120° C., or about 60° C. to 100° C. Agitation of the solution at elevated temperature is carried out for a suitable amount of time to decompose substantially all of the thermal initiator, and react substantially all of the monomers to form a polymer solution. In some embodiments, elevated temperature is maintained for a period of about 2 hours to 24 hours, or about 4 hours to 18 hours, or about 8 hours to 16 hours. During polymerization, it is necessary in some embodiments to add additional thermal initiator to complete the reaction of substantially all of the monomer content added to the reaction vessel. It will be appreciated that completion of the polymerization is achieved by careful adjustment of conditions, and standard analytical techniques such as gas chromatographic analysis of residual monomer content will inform the skilled artisan regarding the completion of polymerization.

In some embodiments, the solvent polymerization as described above is a UV polymerization; that is, a UV initiator is employed instead of a thermal initiator and the polymerization is carried out substantially as described for the solvent polymerization except that the solution is irradiated with UV radiation at a wavelength corresponding to the preferred decomposition wavelength of the selected initiator for a period of time. In some embodiments, solution UV polymerization is carried out without adding heat to the solution. In other embodiments, heat is further added to the solution, for example to facilitate mixing as viscosity of the solution increases during the polymerization process.

It has been found that not all zwitterionic (meth)acrylate-based copolymers are suitable for use as dust suppression compositions. In particular, adhesive polymers are not suitable as they can cause the sand to clump and become non-free flowing. One particularly suitable method for determining the suitability of a copolymer is by measuring the probe tack. Probe tack testing is a commonly used testing protocol to determine the adhesiveness of polymers. The details of the probe tack test method are described in the Examples section, and involve contacting a 5 millimeter diameter stainless steel probe to an adhesive surface and measuring the force necessary to pull the probe away from the adhesive surface. To measure the probe tack value for the dust suppression compositions of this disclosure, the emulsions are dried and the dried layer is tested for probe tack. Generally, zwitterionic (meth)acrylate-based copolymers that are suitable have a probe tack value of 0.51 gram-millimeters or less.

Besides Copolymer A or Copolymer B, the dust suppression compositions of this disclosure may comprise a variety of additives as long as the additives do not interfere with the dust suppression properties of Copolymer A or Copolymer B, and are miscible or dispersible in water or the solvent used to dissolve Copolymer A or Copolymer B. In this context, miscible or dispersible means that the composition sufficiently disperses within the solvent, water or an aqueous mixture so as to not phase separate. Among the suitable additives are glycerol, which is discussed in more detail below, triethylene glycol, tripropylene glycol, polypropylene glycol, polyethylene glycols, sorbitol, hexylene glycol, butylene glycol, naphthenic oils, mineral oil, isoparaffinic oils, and industrial plant oils. The additives may be used singly or in combination.

Also disclosed herein are dust suppression compositions comprising a mixture of either Copolymer A or Copolymer B as described above with a plasticizer. A variety of plasticizers can be used. Examples of suitable plasticizers include oils, such as those described above as additives. Among the suitable plasticizers are polyols, with glycerol being particularly suitable. It has been discovered that the combination of copolymer and a plasticizer such as glycerol gives improved dust suppression over either component by itself.

In some embodiments, the dust suppression composition comprises an emulsion or solution comprising Copolymer A and glycerol. Copolymer A is the polymerized product of about 0 wt % to 5 wt % based on the total weight of the polymer of acrylic acid, methacrylic acid, a carboxylate salt thereof, or a mixture of two or more thereof, wherein the amount of carboxylate salt is determined based on the weight of the corresponding free acid; about 0 wt % to 48 wt % based on the total weight of the polymer of an acrylate or methacrylate ester of an alcohol having between 8 and 12 carbons, or a mixture of two or more thereof; about 2 wt % to 45 wt % based on the total weight of the polymer of an acrylate or methacrylate ester having an alkylammonium functionality; about 0 wt % to 30 wt % based on the total weight of the polymer of vinyl acetate, isobutyl acrylate, N-vinyl pyrrolidone, or a mixture of two or more thereof; about 50 wt % to 95 wt % based on the total weight of the polymer of 2-ethyl hexyl acrylate.

In some embodiments, the dust suppression composition comprises an emulsion or solution comprising Copolymer B and glycerol. Copolymer B is the polymerized product of about 0 wt % to 5 wt % based on the total weight of the polymer of acrylic acid, methacrylic acid, a carboxylate salt thereof, or a mixture of two or more thereof, wherein the amount of carboxylate salt is determined based on the weight of the corresponding free acid; about 50 wt % to 95 wt % based on the total weight of the polymer of an acrylate or methacrylate ester of an alcohol having between 8 and 12 carbons, or a mixture of two or more thereof; about 2 wt % to 45 wt % based on the total weight of the polymer of an acrylate or methacrylate ester having an alkylammonium functionality; about 0 wt % to 30 wt % based on the total weight of the polymer of vinyl acetate, isobutyl acrylate, N-vinyl pyrrolidone, or a mixture of two or more thereof; about 0.1 wt % to 5 wt % based on the total weight of the polymer of at least one free radically polymerizable alkoxysilane.

Glycerol, also known as glycerin or glycerine, is the simple polyol propane 1,2,3-triol, and is a colorless viscous liquid that is readily soluble in water.

Suitable dust suppression compositions of this disclosure include mixtures comprising a wide range of mixture ratios of plasticizer (typically glycerol) to copolymer. Typically, plasticizer is present in higher quantities. In some embodiments, the dust suppression composition comprises a weight ratio of plasticizer to cationic or zwitterionic (meth)acrylate-based copolymer of from 2:1 to 15:1.

As mentioned above, adhesive polymers are not suitable for use as dust suppression compositions as they can cause the mineral materials, for example nepheline syenite or sand mixtures, such as silica sand, to clump and become non-free flowing. One particularly suitable method for determining the suitability of a copolymer is by measuring the probe tack. Probe tack testing is a commonly used testing protocol to determine the adhesiveness of polymers. The details of the probe tack test method are described in the Examples section, and involve contacting a 5 millimeter diameter stainless steel probe to an adhesive surface and measuring the force necessary to pull the probe away from the adhesive surface. To measure the probe tack value for the dust suppression compositions of this disclosure, the emulsions are dried and the dried layer is tested for probe tack. Generally, zwitterionic (meth)acrylate-based copolymers that are suitable have a probe tack value of 0.51 gram-millimeters or less.

Also disclosed are methods for treating mineral materials, for example nepheline syenite or sand mixtures, such as silica sand, to suppress dust generation. These methods comprise providing a mineral mixture with grains larger than 100 micrometer average particle size and comprising dust particles of less than 100 micrometers average particle size, providing a dust suppression composition, treating the mineral mixture with the dust suppression composition to form a treated mineral mixture, optionally drying the treated mineral mixture, dispensing the treated mineral mixture, such that the level of dust particles of less than 100 micrometers generated is reduced compared to an identical mineral mixture that was not treated. In some embodiments, the mineral mixture comprises silica sand or nepheline syenite.

The dust suppression composition may be any of the dust suppression compositions described above. In some embodiments, the dust suppression composition comprises a solution or an emulsion comprising at least one cationic or zwitterionic (meth)acrylate-based copolymer in water, where the at least one cationic or zwitterionic (meth)acrylate-based copolymer comprises either Copolymer A, Copolymer B, or a combination thereof. In other embodiments the dust suppression composition comprises a solution or an emulsion comprising at least one cationic or zwitterionic (meth)acrylate-based copolymer and a plasticizer (typically glycerol). In these embodiments, the at least one cationic or zwitterionic (meth)acrylate-based copolymer comprises either Copolymer A, Copolymer B, or a combination thereof.

The treatment of the mineral mixture with the dust suppression composition can be achieved through any of a wide range of techniques. Typically, the liquid dust suppression composition is mixed with the mineral mixture using standard large scale mixing techniques.

The amount of dust suppression composition added to the mineral mixture depends upon a variety of factors. Among these factors are the identity of the at least one cationic or zwitterionic (meth)acrylate-based copolymer and whether plasticizer is present or not. Typically, when the dust suppression composition comprises Copolymer A, the composition comprising Copolymer A is added at a solids loading level of at least 0.07 pounds per ton of mineral mixture. In embodiments where the dust suppression composition comprises Copolymer B, the composition comprising Copolymer B is added at a solids loading level of at least 0.28 pounds per ton of mineral mixture.

Because emulsions and solutions at varying weight % values of cationic or zwitterionic (meth)acrylate-based copolymer can be used, the dust suppression compositions mixed with mineral mixtures are described by “solids loading level”. This terminology is common in the art, and it is well understood that in this case the solids loading level refers to the total amount of solids added and does not include any water, solvent or other volatile components that do not remain in the mineral mixture after application.

In embodiments where the dust suppression composition comprises an emulsion or solution comprising at least one cationic or zwitterionic (meth)acrylate-based copolymer and plasticizer, the amount of plasticizer included in the dust suppression composition varies widely. For a variety of reasons, glycerol is a particularly suitable plasticizer. In some embodiments, the dust suppression composition comprises a mixture comprising Copolymer A at a solids loading level of at least 0.07 pounds per ton of mineral mixture and glycerol at a level of at least 1.1 pounds per ton of mineral mixture. In other embodiments, the dust suppression composition comprises Copolymer B at a solids loading level of at least 0.28 pounds per ton of mineral mixture and glycerol at a level of at least 1.1 pounds per ton of mineral mixture.

The treated mineral mixtures may be dried if desired. A wide range of drying techniques can be used, including simple air drying. Often the treated sand mixtures are heated to accelerate drying, often through the use of an oven, a heated air stream, or a kiln.

As mentioned above, the dust suppression compositions of this disclosure provide treated mineral mixtures that not only demonstrate dust suppression, but also are free flowing and are essentially free of mineral clumps. Dust suppression compositions that are suitable for the treatment of mineral mixtures are those that have probe tack values of less than 0.51 gram-millimeters, as described above.

### EXAMPLES

These examples are merely for illustrative purposes only and are not meant to be limiting on the scope of the appended claims. All parts, percentages, ratios, etc. in the examples and the rest of the specification are by weight, unless noted otherwise. Solvents and other reagents used were obtained from Sigma-Aldrich Chemical Company; Milwaukee, Wis. unless otherwise noted. The following abbreviations are used: mg=milligrams; g=grams; kg=kilograms; lb=pounds; mm=millimeters; m=meters; sec=seconds. The terms “weight %”, “% by weight”, and “wt %” are used interchangeably.

### Materials

The materials used in the following examples are listed in Table 1A.

TABLE 1A
Materials used in examples

| Commercial Material | Manufacturer | CAS# | Comments |
|---|---|---|---|
| AZAP | 3M | | Synthesized as |
| | | | described below |
| Copolymer A-1 | 3M | | Synthesized as |
| | | | described below |
| Copolymer B-1 | 3M | | Synthesized as |
| | | | described below |
| 3M FASTBOND | 3M | | “3M Adhesive 49” |
| INSULATION | | | |
| ADHESIVE 49 | | | |
| Glycerol | Avantor | 56-81-5 | |
| | Performance | | |
| | Materials (J T | | |
| | Baker) | | |
| 40-70 Mesh Northern | Fairmount- | | |
| White Sand | Santrol | | |

### Polymer Synthesis for AZAP, Copolymer A-1, and Copolymer B-1 Compounds

The following compounds, used in the polymer syntheses, are referred to below using the abbreviations indicated in Table 1B.

TABLE 1B
Abbreviations and sources for compounds
employed in the Examples.

| Abbreviation | Compound | Source |
|---|---|---|
| DMAEA-MeCl | Dimethylaminoethyl acrylate | CIBA, Marrietta, |
| | methyl chloride (2- | GA |
| | trimethylammoniumethyl | |
| | acrylate chloride) | |
| VAc | Vinyl Acetate | Celanese Corp., |
| | | Dallas, TX |
| MA | Methacrylic acid | BASF Corp., |
| | | Ludwigshafen, |
| | | Germany |
| IOA | Isooctyl Acrylate | 3M, St. Paul, MN |
| 2-EHA | 2-Ethylhexyl Acrylate | Dow Chemical Co., |
| | | Midland, MI |
| Initiator-1 | 2,2′-Azobis(2- | Wako Pure Chemical |
| | methylpropionamidine) | Ind., Ltd., Osaka, |
| | dihydrochloride commercially | Japan |
| | available as V-50 | |
| Surfactant-1 | Cocoalkylmethyl[polyoxy- | Akzo Nobel N.V., |
| | ethylene (15)] ammonium | Amsterdam, the |
| | chloride commercially available | Netherlands |
| | as ETHOQUAD C-25. | |
| Silane-1 | 3-(Trimethoxysilyl)propyl | Momentive |
| | methacrylate commercially | Performance |
| | available as SILQUEST A-174 | Materials, |
| | | Waterford, NY |

To synthesize AZAP or Copolymer A-1, the following procedure was used. A clean reaction vessel was charged with 50 parts by weight of the desired monomer mixture, 50 parts by weight of water, and 1 part by weight of Surfactant-1. This mixture was stirred and purged with nitrogen throughout the reaction. The mixture was heated to 40° C., then an initiator mixture was added in a single addition to the vessel and the mixture was heated to 50° C. The initiator mixture consisted of 0.5 parts by weight of Initiator-1 and 2 parts by weight of water. After addition of the initiator mixture, the reaction vessel was stirred at 50° C. for about 8 hours, then another 0.1 parts by weight of the initiator mixture was added to the reaction vessel. The vessel was stirred at 50° C. for an additional 4 hours, and then a sample was removed and analyzed using gas chromatography to determine the amount of unreacted monomer. If less than 0.5 parts of unreacted monomer was present, the mixture was allowed to cool to room temperature. The cooled mixture was stirred and a 10% aqueous NaOH solution was added, to adjust the final pH to 5.5.

For the synthesis of AZAP, the monomer mixture employed was 8 parts by weight DMAEA-MeCl; 5 parts by weight VAc; 85 parts by weight IOA; and 2 parts by weight MA. Total solids of the emulsion was 50 wt %.

For the synthesis of Copolymer A-1, the monomer mixture employed was 8 parts by weight DMAEA-MeCl; 5 parts by weight VAc; 85 parts by weight 2-EHA; and 2 parts by weight MA. Total solids of the emulsion was 50 wt %.

To synthesize Copolymer B-1, the following procedure was used. In a clean reaction bottle, an aqueous solution of monomer, surfactant and initiator was prepared. The monomer mixture employed was 8 parts by weight DMAEA-MeCl; 5 parts by weight VAc; 87 parts by weight IOA; and 2 parts by weight Silane-1. The surfactant was 0.25 part by weight Surfactant-1. The initiator was 0.5 parts by weight Initiator-1. 122.2 parts by weight of water was used. The mixture was purged with nitrogen for 2 minutes. The reaction bottle was sealed and placed in a 50° C. preheated water bath with mixing mechanism. The reaction mixture was heated for 17 hours at 50° C. with mixing. A stable milky white emulsion polymer was produced. The reaction mixture was analyzed by % solids analysis.

### Method for Sand Treatment

The following steps were performed in order:
1. Weigh out 1 kg of 40-70 mesh sand.
2. Sieve through 100 mesh screen with shaking for 5 minutes. Weigh and record the amount of fines collected beneath the sieve.
3. Mix emulsion and glycerol in proper amounts in a weigh boat, and dilute with 30 g deionized water, shaking dish to mix.
4. Transfer sand to a metal can on a paint shaker.
5. Turn on the shaker and pour solution over sand while the can is moving.
6. Allow the sand to shake for 90 seconds.
7. Remove the contents and transfer the sand to a 11″×17″ enamel pan
8. Place the treated sand in a 240° F. oven for 30 minutes to dry to 0.02-0.03% dryness as measured with a Mettler-Toledo MJ33 moisture analyzer.
9. Remove from oven and allow to cool a minimum of 3 h.

### Granule Dust Test

A dust measurement of the treated sand was performed using a DustTrak DRX Aerosol Monitor Model 8533 available from TSI Incorporated, Shoreview, Minn. A fabricated 4.5″×3.5″×4.5″ dust chamber was attached by a hose to the inlet of the DustTrak. 400 g of treated sand was released from a funnel into the chamber while simultaneously running the DustTrak for one minute. The average total dust reading was recorded in mg/m³.

### Examples 1-26 and Comparative Examples C1-C10

40-70 mesh silica sand from Fairmount-Santrol (Menomonie, Wis.) was sieved with a 100 mesh screen so as to remove excess fines smaller than 150 micrometers. The coating solutions were prepared, and the sand was coated and dried as described above in the Method for Sand Treatment. The dust was measured according to the Granule Dust Test described above. Controls, shown as Comparative Examples, included as-delivered sand (bare sand), as-delivered sand that was treated only with clean water (bare wet sand), and sieved sand that received no treatment (bare sand (sieved).) Coatings included AZAP, Copolymer B-1, and Copolymer B-1/glycerol mixtures. Four replicates were performed for each of the coatings; two replicates were performed for Comparative Examples. Results are shown in Table 2.

TABLE 2
Dust Test Values for Examples 1-26 and Comp. Exs. C1-C10

| | | Polymer | | |
|---|---|---|---|---|
| | | Solids | | |
| | | Loading | Glycerol | Dust |
| Example | Coating | (lb/ton) | (lb/ton) | (mg/m³) |
| 1 | COPOLYMER B-1 | 0.28 | 0.00 | 108 |
| 2 | COPOLYMER B-1 | 0.28 | 0.00 | 114 |
| 3 | COPOLYMER B-1 | 0.28 | 0.00 | 109 |
| 4 | COPOLYMER B-1 | 0.28 | 0.00 | 106 |
| 5 | COPOLYMER B-1 | 0.41 | 0.00 | 73.6 |
| 6 | COPOLYMER B-1 | 0.41 | 0.00 | 78.3 |
| 7 | COPOLYMER B-1 | 0.41 | 0.00 | 85.9 |
| 8 | COPOLYMER B-1 | 0.41 | 0.00 | 84.1 |
| 9 | COPOLYMER B-1 | 0.55 | 0.00 | 51.4 |
| 10 | COPOLYMER B-1 | 0.55 | 0.00 | 50 |
| 11 | COPOLYMER B-1 | 0.55 | 0.00 | 72.1 |
| 12 | COPOLYMER B-1 | 0.55 | 0.00 | 46 |
| 13 | COPOLYMER B-1 | 0.69 | 0.00 | 17.2 |
| 14 | COPOLYMER B-1 | 0.69 | 0.00 | 19.9 |
| 15 | COPOLYMER B-1 | 0.69 | 0.00 | 31.3 |
| 16 | COPOLYMER B-1 | 0.69 | 0.00 | 38.7 |
| 17 | COPOLYMER B-1 | 0.87 | 0.00 | 20.4 |
| 18 | COPOLYMER B-1 | 0.87 | 0.00 | 8.85 |
| 19 | COPOLYMER B-1 | 0.83 | 0.00 | 14.9 |
| 20 | COPOLYMER B-1 | 0.83 | 0.00 | 20.2 |
| 21 | COPOLYMER B-1/glycerol | 0.28 | 2.20 | 2.38 |
| 22 | COPOLYMER B-1/glycerol | 0.28 | 2.20 | 1.11 |
| 23 | COPOLYMER B-1/glycerol | 0.28 | 1.10 | 8.55 |
| 24 | COPOLYMER B-1/glycerol | 0.28 | 1.10 | 7.04 |
| 25 | COPOLYMER B-1/glycerol | 0.28 | 0.22 | 85.4 |
| 26 | COPOLYMER B-1/glycerol | 0.28 | 0.22 | 78.9 |
| C1 | bare sand | 0.00 | 0.00 | 85.5 |
| C2 | bare sand | 0.00 | 0.00 | 92.7 |
| C3 | bare wet sand | 0.00 | 0.00 | 96.8 |
| C4 | bare wet sand | 0.00 | 0.00 | 105 |
| C5 | bare sand (sieved) | 0.00 | 0.00 | 100 |
| C6 | bare sand (sieved) | 0.00 | 0.00 | 87.1 |
| C7 | AZAP | 0.26 | 0.00 | 74.8 |
| C8 | AZAP | 0.26 | 0.00 | 60.2 |
| C9 | AZAP | 0.26 | 0.00 | 70.7 |
| C10 | AZAP | 0.26 | 0.00 | 60.1 |

At a loading of 0.26 lb/treated ton, AZAP reduced the generated dust by a significant fraction, but already exhibited slight flocculation of the sand, indicating the onset of impairment of the flow properties of the sand. Higher loadings resulted in sticky clumps of sand.

At 0.28 lb/treated ton of COPOLYMER B-1 alone, there was essentially no reduction in dust generation, but the dust decreased at higher loadings of COPOLYMER B-1. The dust generation seemed to be approaching a minimum at loadings of 0.83 lb/ton and greater, but even at these high loadings, the treated sand flowed like the controls when handled.

At 0.28 lb/treated ton of COPOLYMER B-1 and varying levels of glycerol, substantially improved dust reduction could be achieved. A loading of 0.22 lb/treated ton of glycerol resulted in an improvement over sand treated with 0.28 lb/ton COPOLYMER B-1 alone, but flow properties were still nearly indistinguishable from the sieved sand control. Keeping the COPOLYMER B-1 level the same and increasing the glycerol to 1.1 lb/ton dramatically reduced the dust, and resulted in better performance than any tested level of COPOLYMER B-1 loading alone. The glycerol could be increased to 2.2 lb/ton before the onset of compromised flow properties was observed.

### Example 27-64 and Comparative Examples C11-C28

40-70 mesh silica sand was treated as described in Examples 1-26 with COPOLYMER B-1, glycerol, or a COPOLYMER B-1/glycerol mixture. Results are shown in Table 3. Several results from Table 2 are included in Table 3 for ease of comparison. Substantial reduction of dust generation is possible even at 0.14 lb/ton COPOLYMER B-1 and at 1.1 lb/ton (0.5 g/kg) glycerol. No impairment of flow properties was observed except for the condition of 2.2 lb/ton (1 g/kg) glycerol with no added emulsion. Four replicates were measured for each of the coated samples; two replicates were measured for each of the Comparative Examples.

TABLE 3
Dust Test Values for Examples 27-64, Comparative
Examples C11-C28 and selected previous Examples

| | | Polymer | | |
|---|---|---|---|---|
| | | Solids | | |
| | | Loading | Glycerol | Dust |
| Sample | Coating | (lb/ton) | (lb/ton) | (mg/m³) |
| 22 | COPOLYMER B-1/glycerol | 0.28 | 2.20 | 1.11 |
| 21 | COPOLYMER B-1/glycerol | 0.28 | 2.20 | 2.38 |
| 27 | COPOLYMER B-1/glycerol | 0.28 | 2.20 | 0.327 |
| 28 | COPOLYMER B-1/glycerol | 0.28 | 2.20 | 0.493 |
| 29 | COPOLYMER B-1/glycerol | 0.28 | 2.20 | 0.792 |
| 30 | COPOLYMER B-1/glycerol | 0.28 | 2.20 | 1.09 |
| 31 | COPOLYMER B-1/glycerol | 0.28 | 1.10 | 7.04 |
| 32 | COPOLYMER B-1/glycerol | 0.28 | 1.10 | 8.55 |
| 33 | COPOLYMER B-1/glycerol | 0.28 | 1.10 | 2.82 |
| 34 | COPOLYMER B-1/glycerol | 0.28 | 1.10 | 3.84 |
| 35 | COPOLYMER B-1/glycerol | 0.28 | 1.10 | 8.68 |
| 36 | COPOLYMER B-1/glycerol | 0.28 | 1.10 | 10.2 |
| 37 | COPOLYMER B-1/glycerol | 0.28 | 0.22 | 78.9 |
| 38 | COPOLYMER B-1/glycerol | 0.28 | 0.22 | 85.4 |
| 39 | COPOLYMER B-1/glycerol | 0.28 | 0.22 | 82.5 |
| 40 | COPOLYMER B-1/glycerol | 0.28 | 0.22 | 77.7 |
| 41 | COPOLYMER B-1/glycerol | 0.28 | 0.22 | 54.2 |
| 42 | COPOLYMER B-1/glycerol | 0.28 | 0.22 | 53.7 |
| C11 | Glycerol | 0.00 | 0.22 | 100 |
| C12 | Glycerol | 0.00 | 0.22 | 83 |
| C13 | Glycerol | 0.00 | 1.10 | 46.2 |
| C14 | Glycerol | 0.00 | 1.10 | 38.6 |
| C15 | Glycerol | 0.00 | 2.20 | 4.86 |
| C16 | Glycerol | 0.00 | 2.20 | 6.25 |
| 43 | COPOLYMER B-1/glycerol | 0.14 | 1.10 | 20.8 |
| 44 | COPOLYMER B-1/glycerol | 0.14 | 1.10 | 24.4 |
| 45 | COPOLYMER B-1/glycerol | 0.14 | 2.20 | 25.4 |
| 46 | COPOLYMER B-1/glycerol | 0.14 | 2.20 | 13.8 |
| 47 | COPOLYMER B-1/glycerol | 0.14 | 0.00 | 88 |
| 48 | COPOLYMER B-1/glycerol | 0.14 | 0.00 | 97.2 |
| C1 | bare sand | 0.00 | 0.00 | 85.5 |
| C2 | bare sand | 0.00 | 0.00 | 92.7 |
| C3 | bare wet sand | 0.00 | 0.00 | 96.8 |
| C4 | bare wet sand | 0.00 | 0.00 | 105 |
| C5 | bare sand (sieved) | 0.00 | 0.00 | 100 |
| C6 | bare sand (sieved) | 0.00 | 0.00 | 87.1 |
| C17 | Glycerol | 0.00 | 0.22 | 88.8 |
| C18 | Glycerol | 0.00 | 0.22 | 94.1 |
| C19 | Glycerol | 0.00 | 0.22 | 91.2 |
| C20 | Glycerol | 0.00 | 0.22 | 87.8 |
| C21 | Glycerol | 0.00 | 1.10 | 36.2 |
| C22 | Glycerol | 0.00 | 1.10 | 47.4 |
| C23 | Glycerol | 0.00 | 1.10 | 59 |
| C24 | Glycerol | 0.00 | 1.10 | 37.8 |
| C25 | Glycerol | 0.00 | 2.20 | 0.351 |
| C26 | Glycerol | 0.00 | 2.20 | 0.31 |
| C27 | Glycerol | 0.00 | 2.20 | 1.07 |
| C28 | Glycerol | 0.00 | 2.20 | 0.6 |
| 49 | COPOLYMER B-1 | 0.14 | 0.00 | 69.6 |
| 50 | COPOLYMER B-1 | 0.14 | 0.00 | 76.4 |
| 51 | COPOLYMER B-1 | 0.14 | 0.00 | 89.9 |
| 52 | COPOLYMER B-1 | 0.14 | 0.00 | 66.1 |
| 53 | COPOLYMER B-1/glycerol | 0.14 | 1.10 | 5.86 |
| 54 | COPOLYMER B-1/glycerol | 0.14 | 1.10 | 9.6 |
| 55 | COPOLYMER B-1/glycerol | 0.14 | 1.10 | 21.5 |
| 56 | COPOLYMER B-1/glycerol | 0.14 | 1.10 | 24.9 |
| 57 | COPOLYMER B-1/glycerol | 0.14 | 2.20 | 0.757 |
| 58 | COPOLYMER B-1/glycerol | 0.14 | 2.20 | 0.53 |
| 59 | COPOLYMER B-1/glycerol | 0.14 | 2.20 | 0.625 |
| 60 | COPOLYMER B-1/glycerol | 0.14 | 2.20 | 1.35 |
| 61 | COPOLYMER B-1 | 0.28 | 0.00 | 76.3 |
| 62 | COPOLYMER B-1 | 0.28 | 0.00 | 98.4 |
| 63 | COPOLYMER B-1 | 0.28 | 0.00 | 73.2 |
| 64 | COPOLYMER B-1 | 0.28 | 0.00 | 99.8 |

### Examples 65-90 and Comparative Examples C29-C30

40-70 mesh silica sand was treated as described in previous Examples, but with Copolymer A-1, glycerol, or a Copolymer A-1/glycerol mixture. Results are shown in Table 4. Several results from Tables 2 and 3 are included in Table 4 for ease of comparison. Substantial reduction of dust generation is possible even at 0.07 lb/ton Copolymer A-land at 1.1 lb/ton (0.5 g/kg) glycerol. No impairment of flow properties was observed except for the condition of 2.2 lb/ton (1 g/kg) glycerol with no added emulsion. At a glycerol loading of 1.1 lb/ton, an emulsion loading of 0.07 lb/ton produced less noisy dust results than an emulsion loading of 0.13 lb/ton. Two to four replicates were measured for each of the coated samples; two replicates were measured for all Comparative Examples.

TABLE 4
Dust Test Values for Examples 65-90, Comparative
Examples C29-C30 and selected previous Examples

| | | Polymer | | |
|---|---|---|---|---|
| | | Solids | | |
| | | Loading | Glycerol | Dust |
| Sample | Coating | (lb/ton) | (lb/ton) | (mg/m³) |
| 65 | Copolymer A-1/glycerol | 0.13 | 2.20 | 0.886 |
| 66 | Copolymer A-1/glycerol | 0.13 | 2.20 | 0.471 |
| 67 | Copolymer A-1/glycerol | 0.13 | 1.10 | 2.4 |
| 68 | Copolymer A-1/glycerol | 0.13 | 1.10 | 4.41 |
| 69 | Copolymer A-1/glycerol | 0.13 | 0.22 | 34.3 |
| 70 | Copolymer A-1/glycerol | 0.13 | 0.22 | 46.3 |
| 71 | Copolymer A-1/glycerol | 0.07 | 2.20 | 0.567 |
| 72 | Copolymer A-1/glycerol | 0.07 | 2.20 | 0.572 |
| 73 | Copolymer A-1/glycerol | 0.07 | 1.10 | 5.13 |
| 74 | Copolymer A-1/glycerol | 0.07 | 1.10 | 9.18 |
| 75 | Copolymer A-1/glycerol | 0.07 | 0.22 | 66.8 |
| 76 | Copolymer A-1/glycerol | 0.07 | 0.22 | 77.1 |
| C29 | Glycerol | 0.00 | 1.10 | 26.6 |
| C30 | Glycerol | 0.00 | 1.10 | 62.2 |
| C1 | bare sand | 0.00 | 0.00 | 85.5 |
| C2 | bare sand | 0.00 | 0.00 | 92.7 |
| C3 | bare wet sand | 0.00 | 0.00 | 96.8 |
| C4 | bare wet sand | 0.00 | 0.00 | 105 |
| C5 | bare sand (sieved) | 0.00 | 0.00 | 100 |
| C6 | bare sand (sieved) | 0.00 | 0.00 | 87.1 |
| C13 | Glycerol | 0.00 | 1.10 | 46.2 |
| C14 | Glycerol | 0.00 | 1.10 | 38.6 |
| C15 | Glycerol | 0.00 | 0.22 | 100 |
| C16 | Glycerol | 0.00 | 0.22 | 83 |
| C17 | Glycerol | 0.00 | 2.20 | 4.86 |
| C18 | Glycerol | 0.00 | 2.20 | 6.25 |
| 77 | Copolymer A-1/glycerol | 0.13 | 1.10 | 38.4 |
| 78 | Copolymer A-1/glycerol | 0.13 | 1.10 | 34.6 |
| 79 | Copolymer A-1/glycerol | 0.07 | 1.10 | 7.84 |
| 80 | Copolymer A-1/glycerol | 0.07 | 1.10 | 5.01 |
| 81 | Copolymer A-1/glycerol | 0.07 | 1.10 | 4.05 |
| 82 | Copolymer A-1/glycerol | 0.07 | 1.10 | 13.3 |
| 83 | Copolymer A-1 | 0.13 | 0.00 | 50.3 |
| 84 | Copolymer A-1 | 0.13 | 0.00 | 55.3 |
| 85 | Copolymer A-1 | 0.07 | 0.00 | 73.7 |
| 86 | Copolymer A-1 | 0.07 | 0.00 | 65.8 |
| 87 | Copolymer A-1/glycerol | 0.13 | 1.10 | 23.8 |
| 88 | Copolymer A-1/glycerol | 0.13 | 1.10 | 31.2 |
| 89 | Copolymer A-1/glycerol | 0.13 | 1.10 | 8.4 |
| 90 | Copolymer A-1/glycerol | 0.13 | 1.10 | 12.7 |

Table 4 shows that there is a window of loadings where dust generation resulting from sand treated with the combination of Copolymer A-1 and glycerol is substantially reduced relative to that resulting from sand treated either with pure glycerol or pure emulsion.

### Examples 91-92 and Comparative Example C31-C32

Neat films of the three polymers employed in the previous Examples and Comparative Examples, and of 3M Adhesive 49, were made. The stiffness, tack and work of adhesion of the four polymers were measured and are summarized in Table 5. The tack, stiffness, and WOA measurements were performed on a TA.XT PLUS texture analyzer (Stable Micro Systems, Godalming, Surrey, UK), using a 5 mm hemi-spherical stainless steel probe. The probe was brought into contact with the adhesive tape (adhesive thickness 1 mil) at 0.5 mm/sec until a 25 g pre-force was registered. After dwell time t, the probe was retracted at a rate of 0.5 mm/sec until complete pull-off. For tack measurements dwell time was 3 seconds, and for WOA measurements, dwell time was 180 seconds. Tack and WOA were calculated as the area of the pull-off curve, whereas stiffness was calculated as the slope of the pre-force curve. Values are reported as the mean and the standard deviation from 6 measurements. All measurements were performed at 75° F. and 50% relative humidity.

It had been previously observed that application of 3M Adhesive 49 adhesive to fine particles results in “glue balls”. Application of AZAP to 40-70 mesh sand resulted in free-flowing sand only at loadings less than 0.26 lb/treated ton. Application of COPOLYMER B-1 to 40-70 mesh sand at loadings at least up to 0.83 lb/treated ton resulted in no restriction of flow properties. This sequence of retention of flow properties:

COPOLYMER B-1>Copolyme A-1>AZAP>3M Adhesive 49

was inversely related to tack, and work of adhesion, as expected.

TABLE 5
Stiffness, tack and work of adhesion measurements
for neat films of the polymers employed in Examples
and Comparative Examples and for 3M Adhesive 49.

| | | | | Work of |
|---|---|---|---|---|
| | | Stiffness | Probe Tack | Adhesion |
| Example | Polymer | (g/sec) | (g-mm) | (g-mm) |
| 91 | Copolymer B-1 | 50 ± 2.1 | 0.38 ± 0.03 | 0.72 ± 0.04 |
| 92 | Copolymer A-1 | 132 ± 2.1 | 0.47 ± 0.01 | 0.86 ± 0.05 |
| C31 | AZAP | 180 ± 4.8 | 0.51 ± 0.01 | 0.93 ± 0.02 |
| C32 | 3M Adhesive 49 | 250 ± 7.3 | 0.97 ± 0.02 | 2.1 ± 0.07 |

What is claimed is:

1. A dust suppression composition comprising:
at least one cationic or zwitterionic (meth)acrylate-based copolymer; and
at least one solvent, wherein the at least one cationic or zwitterionic (meth)acrylate-based copolymer comprises:
Copolymer A, the polymerized product of:
about 0 wt % to 5 wt % based on the total weight of the polymer of acrylic acid, methacrylic acid, a carboxylate salt thereof, or a mixture of two or more thereof, wherein the amount of carboxylate salt is determined based on the weight of the corresponding free acid;
about 0 wt % to 48 wt % based on the total weight of the polymer of an acrylate or methacrylate ester of an alcohol having between 8 and 12 carbons, or a mixture of two or more thereof;
about 2 wt % to 45 wt % based on the total weight of the polymer of an acrylate or methacrylate ester having an alkylammonium functionality;
about 0 wt % to 30 wt % based on the total weight of the polymer of vinyl acetate, isobutyl acrylate, N-vinyl pyrrolidone, or a mixture of two or more thereof;
about 50 wt % to 95 wt % based on the total weight of the polymer of 2-ethyl hexyl acrylate; or
Copolymer B, the polymerized product of:
about 0 wt % to 5 wt % based on the total weight of the polymer of acrylic acid, methacrylic acid, a carboxylate salt thereof, or a mixture of two or more thereof, wherein the amount of carboxylate salt is determined based on the weight of the corresponding free acid;
about 50 wt % to 95 wt % based on the total weight of the polymer of an acrylate or methacrylate ester of an alcohol having between 8 and 12 carbons, or a mixture of two or more thereof;
about 2 wt % to 45 wt % based on the total weight of the polymer of an acrylate or methacrylate ester having an alkylammonium functionality;
about 0 wt % to 30 wt % based on the total weight of the polymer of vinyl acetate, isobutyl acrylate, N-vinyl pyrrolidone, or a mixture of two or more thereof;
about 0.1 wt % to 5 wt % based on the total weight of the polymer of at least one free radically polymerizable alkoxysilane.

2. The dust suppression composition of claim 1, wherein the at least one cationic or zwitterionic (meth)acrylate-based copolymer, when coated and dried has a probe tack value of less than 0.51 gram-millimeters.

3. The dust suppression composition of claim 1, wherein the at least one solvent is water and the dust suppression composition is an emulsion.

4. The dust suppression composition of claim 1, wherein the at least one solvent is a non-water solvent and the dust suppression composition is a solution.

5. The dust suppression composition further comprising at least one additive selected from glycerol, triethylene glycol, tripropylene glycol, polypropylene glycol, a polyethylene glycol, sorbitol, hexylene glycol, butylene glycol, a naphthenic oil, mineral oil, an isoparaffinic oil, an industrial plant oil, or a combination thereof.

6. A dust suppression composition comprising:
at least one cationic or zwitterionic (meth)acrylate-based copolymer;
at least one solvent; wherein the at least one cationic or zwitterionic (meth)acrylate-based copolymer comprises:
Copolymer A, the polymerized product of:
about 0 wt % to 5 wt % based on the total weight of the polymer of acrylic acid, methacrylic acid, a carboxylate salt thereof, or a mixture of two or more thereof, wherein the amount of carboxylate salt is determined based on the weight of the corresponding free acid;
about 0 wt % to 48 wt % based on the total weight of the polymer of an acrylate or methacrylate ester of an alcohol having between 8 and 12 carbons, or a mixture of two or more thereof;
about 2 wt % to 45 wt % based on the total weight of the polymer of an acrylate or methacrylate ester having an alkylammonium functionality;
about 0 wt % to 30 wt % based on the total weight of the polymer of vinyl acetate, isobutyl acrylate, N-vinyl pyrrolidone, or a mixture of two or more thereof;
about 50 wt % to 95 wt % based on the total weight of the polymer of 2-ethyl hexyl acrylate; or
Copolymer B, the polymerized product of:
about 0 wt % to 5 wt % based on the total weight of the polymer of acrylic acid, methacrylic acid, a carboxylate salt thereof, or a mixture of two or more thereof, wherein the amount of carboxylate salt is determined based on the weight of the corresponding free acid;
about 50 wt % to 95 wt % based on the total weight of the polymer of an acrylate or methacrylate ester of an alcohol having between 8 and 12 carbons, or a mixture of two or more thereof;
about 2 wt % to 45 wt % based on the total weight of the polymer of an acrylate or methacrylate ester having an alkylammonium functionality;
about 0 wt % to 30 wt % based on the total weight of the polymer of vinyl acetate, isobutyl acrylate, N-vinyl pyrrolidone, or a mixture of two or more thereof;
about 0.1 wt % to 5 wt % based on the total weight of the polymer of at least one free radically polymerizable alkoxysilane; and
a plasticizer.

7. The dust suppression composition of claim 6, wherein the plasticizer comprises an oil.

8. The dust suppression composition of claim 6, wherein the plasticizer comprises a polyol.

9. The dust suppression composition of claim 8, wherein the plasticizer comprises glycerol.

10. The dust suppression composition of claim 6, wherein the composition comprises a weight ratio of plasticizer to cationic or zwitterionic (meth)acrylate-based copolymer of from 2:1 to 15:1.

11. The dust suppression composition of claim 6, wherein the at least one cationic or zwitterionic (meth)acrylate-based copolymer, when coated and dried has a probe tack value of less than 0.51 gram-millimeters.

12. The dust suppression composition of claim 6, wherein the at least one solvent is water and the dust suppression composition is an emulsion.

13. The dust suppression composition of claim 6, wherein the at least one solvent is a non-water solvent and the dust suppression composition is a solution.

14. A method for treating mineral mixtures to suppress dust generation comprising:
providing a mineral mixture with grains larger than 100 micrometer average particle size and comprising dust particles of less than 100 micrometer average particle size;
providing a dust suppression composition comprising:
at least one cationic or zwitterionic (meth)acrylate-based copolymer; and
at least one solvent; wherein the at least one cationic or zwitterionic (meth)acrylate-based copolymer comprises:
Copolymer A, the polymerized product of:
about 0 wt % to 5 wt % based on the total weight of the polymer of acrylic acid, methacrylic acid, a carboxylate salt thereof, or a mixture of two or more thereof, wherein the amount of carboxylate salt is determined based on the weight of the corresponding free acid;
about 0 wt % to 48 wt % based on the total weight of the polymer of an acrylate or methacrylate ester of an alcohol having between 8 and 12 carbons, or a mixture of two or more thereof;
about 2 wt % to 45 wt % based on the total weight of the polymer of an acrylate or methacrylate ester having an alkylammonium functionality;
about 0 wt % to 30 wt % based on the total weight of the polymer of vinyl acetate, isobutyl acrylate, N-vinyl pyrrolidone, or a mixture of two or more thereof;
about 50 wt % to 95 wt % based on the total weight of the polymer of 2-ethyl hexyl acrylate; or
Copolymer B, the polymerized product of:
about 0 wt % to 5 wt % based on the total weight of the polymer of acrylic acid, methacrylic acid, a carboxylate salt thereof, or a mixture of two or more thereof, wherein the amount of carboxylate salt is determined based on the weight of the corresponding free acid;
about 50 wt % to 95 wt % based on the total weight of the polymer of an acrylate or methacrylate ester of an alcohol having between 8 and 12 carbons, or a mixture of two or more thereof;
about 2 wt % to 45 wt % based on the total weight of the polymer of an acrylate or methacrylate ester having an alkylammonium functionality;
about 0 wt % to 30 wt % based on the total weight of the polymer of vinyl acetate, isobutyl acrylate, N-vinyl pyrrolidone, or a mixture of two or more thereof;
about 0.1 wt % to 5 wt % based on the total weight of the polymer of at least one free radically polymerizable alkoxysilane;
treating the mineral mixture with the dust suppression composition to form a treated mineral mixture;
dispensing the treated mineral mixture, such that the level of dust particles of less than 100 micrometers generated is reduced compared to an identical mineral mixture that was not treated.

15. The method of claim 14, wherein treating the mineral mixture with the dust suppression composition comprises adding the composition comprising Copolymer A to the mineral mixture at a solids loading level of at least 0.07 pounds per ton of mineral mixture, or adding the composition comprising Copolymer B to the mineral mixture at a solids loading level of at least 0.28 pounds per ton of mineral mixture.

16. The method of claim 14, wherein the dust suppression composition further comprises a plasticizer.

17. The method of claim 16, wherein the plasticizer comprises glycerol.

18. The method of claim 17, wherein treating the mineral mixture with the dust suppression composition comprises adding a mixture comprising the composition comprising Copolymer A to the mineral mixture at a solids loading level of at least 0.07 pounds per ton of mineral mixture and glycerol at a level of at least 1.1 pounds per ton of mineral mixture.

19. The method of claim 17, wherein treating the mineral mixture with the dust suppression composition comprises adding the composition comprising Copolymer B to the mineral mixture at a solids loading level of at least 0.28 pounds per ton of mineral mixture and glycerol at a level of at least 1.1 pounds per ton of mineral mixture.

20. The method of claim 14, wherein the at least one cationic or zwitterionic (meth)acrylate-based copolymer, when coated and dried has a probe tack value of less than 0.51 gram-millimeters.

21. The method of claim 14, wherein the treated mineral mixture is essentially free of mineral clumps.

22. The method of claim 14, wherein the mineral comprises silica sand or nepheline syenite.

23. The method of claim 14, wherein the treated mineral mixture is dried.
